(19) United States
(12) Patent Application Publication
(10) Pub. No.: US 2019/0129377 A1
(43) Pub. Date: May 2, 2019

(54) METHODS AND SYSTEMS FOR UTILIZING RE-USABLE AND RE-CONFIGURABLE REPORTER MODULES IN WELDING-TYPE SETUPS

(71) Applicant: Illinois Tool Works Inc., Glenview, IL (US)

(72) Inventors: Michael Gill, Black Creek, WI (US); Praveen Dandu, Appleton, WI (US); Todd Holverson, Appleton, WI (US); Adam Kirk Pliska, Neenah, WI (US)

(21) Appl. No.: 15/802,211

(22) Filed: Nov. 2, 2017

(51) Int. Cl. G05B 19/408; B23K 31/02

(52) U.S. Cl. CPC G05B 19/408; G05B 2219/45135; B23K 31/02

(57) ABSTRACT

Systems and methods are provided for utilizing re-usable and re-configurable reporter modules in welding-type setups. A hardware-based reporting module may be used to handle reporting function. The hardware-based reporting module being configured to interface with a welding-type setup, to obtain welding-type data associated with the welding-type setup; and to interface with a remote central repository for communicating the obtained welding-type data, based on a predefined reporting format. The hardware-based reporting module is configured to process the welding-type data for communication to the remote central repository.

### BACKGROUND

Welding has increasingly become ubiquitous. Welding can be performed in an automated manner or in a manual manner (e.g., being performed by a human). Equipment or components used during welding operations may be driven using engines. For example, engines may be used to drive, for example, generators, power sources, etc. used during welding operations.

In some instances, it may be desirable to collect data in welding-type systems and/or setups, such as data relating to the welding operations and/or functions of various components or devices used in conjunction with the welding operations. Such collected data may be provided to remote entities (e.g., remote servers). However, conventional approaches for supporting such data collection and reporting functions in welding-type systems and/or setups, if any existed, may be cumbersome, inefficient, and/or costly.

Further limitations and disadvantages of conventional approaches will become apparent to one management of skill in the art, through comparison of such approaches with some aspects of the present method and system set forth in the remainder of this disclosure with reference to the drawings.

### BRIEF SUMMARY

Aspects of the present disclosure relate to welding-type operations. More specifically, various implementations in accordance with the present disclosure are directed to utilizing re-usable and re-configurable reporter modules in welding-type setups, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 shows an example system that may be used for welding-type operations, in accordance with aspects of the present disclosure.

FIG. 2 depicts an example welding-type system that utilized re-usable and re-configurable reporting module, in accordance with aspects of this disclosure.

FIG. 3 depicts an example adaptive reporting module, in accordance with aspects of this disclosure.

### DETAILED DESCRIPTION

Various implementations in accordance with the present disclosure are directed to providing enhanced and optimized data collection and reporting in welding-type setups and/or systems. In this regard, in existing solutions, data collections and reporting functions are incorporated into a single entity, and/or the reporting functions are handled by components that are designed and configured based on type and/or architecture of the welding-type setup or system). Such approaches have some disadvantages, however. In particular, a major disadvantage in these existing solutions that are based on the integrated approach is lack of portability. In this regard, existing solutions require configuring and/or re-configuring the reporting functions for all possible architectures, even though at least part of the reporting functions is not really affected nor is it dependent on type or architecture of the welding setup—e.g., because the way in which the data is reported typically is the same irrespective of the variations in architectures used in the welding setups, resulting in substantial unnecessary increase complexity and cost.

Accordingly, it may be desirable to provide reporting solutions that are more efficient and optimized, particularly with respect to portability and flexibility (in making updates or modifications that may apply seamlessly to different welding types or architectures). The present disclosure provides such enhanced solutions, particularly by utilizing separate reporting and data collections functions and components, with the reporting components being designed and implemented as platform-independent component. The advantages of these enhanced solutions include faster development cycles, since development work (e.g., fixes, modifications, etc.) may be re-used seamlessly in various types and architectures. Further, a single codebase may be maintained for all products, as the reporting functions are implemented as platform-independent, which makes more efficient use of resources. In addition, porting new reporting components is greatly simplified, as it becomes an interface-related configuration.

An example welding-type apparatus in accordance with the present disclosure may comprise a data collection component configured based on a particular architecture of a welding-type setup and a reporting component configured based on a uniform architecture that is independent from the particular architecture of the welding-type setup, with the data collection component comprising one or more circuits for collecting welding-type data from the welding-type setup, and the reporting component comprising one or more circuits for handling communication of the collected welding-type data to a remote central repository. The data collection component may be operable to interface with components of the welding-type setup to collect the welding-type data. The components may comprise a welding-type power supply for providing welding-type power; a welding-type torch, driven by the welding-type power supply, configured for applying welds; and a welding-type connector configured for connecting the welding-type power supply to the welding-type torch. The reporting component may be operable to interface with the data collection component to obtain the collected welding-type data, and to interface with remote central repository to communicate the collected welding-type data based on a uniform reporting standard.

In an example implementation, the reporting component may be operable to generate packets carrying the collected welding-type data based on the uniform reporting standard.

In an example implementation, the reporting component may be operable to process the collected welding-type data based on a predefined reporting format.

The predefined reporting format may comprise a uniform format that is independent of type and/or architecture of welding-type setups.

In an example implementation, the reporting component comprises a single board computer (SBC) based circuitry.

In an example implementation, the reporting component comprises a system on a module (SOM) based circuitry.

In an example implementation, the data collection component may be incorporated into one of the components of the welding-type setup. The one of the components of the welding-type setup may comprise a welding-type power supply.

In an example implementation, the reporting component may be operable to receive from the remote central repository updates or modifications to reporting functions, and to apply the updates or modifications.

In an example implementation, the reporting component may be operable to store the obtained welding-type data in accordance with one or more storage criteria.

In an example implementation, one or both of the data collection component and the reporting component may be incorporated into one of the components of the welding-type setup.

An example hardware-based reporting module in accordance with the present disclosure may comprise one or more communication circuits configured to interface with a welding-type setup, to obtain welding-type data associated with the welding-type setup; and interface with a remote central repository for communicating the obtained welding-type data, based on a predefined reporting format; and one or more processing circuits configured for handling reporting the welding-type data for communication to and/or from the remote central repository.

In an example implementation, the one or more communication circuits may be configured to interface with a dedicated data collection component of the welding-type setup that handles collection of welding-type data from remaining components of the welding-type setup.

In an example implementation, the one or more processing circuits may be operable to generate packets carrying the obtained welding-type data based on the uniform reporting standard.

In an example implementation, the wherein one or more processing circuits may be operable to process the obtained welding-type data to conform to a uniform and a common format.

In an example implementation, the hardware-based reporting module may be implemented as a single board computer (SBC).

In an example implementation, the hardware-based reporting module may be implemented as a system on a module (SOM).

In an example implementation, the reporting component may comprise a storage circuit, and may be operable to store the obtained welding-type data in accordance with one or more storage criteria.

In an example implementation, the hardware-based reporting module may be incorporated into a component of the welding-type setup. The component of the welding-type setup comprises one of a welding-type power supply for providing welding-type power; a welding-type torch, driven by the welding-type power supply, configured for applying welds; a welding-type connector configured for connecting the welding-type power supply to the welding-type torch; and a dedicated data collection component that may be operable to handle collection of welding-type data from remaining components of the welding-type setup.

In an example implementation, the one or more communication circuits may be configured to receive from the remote central repository updates or modifications to reporting functions or messages to be displayed; and the one or more processing circuits may be configured to apply the updates or modifications.

In an example implementation, the predefined reporting format may be based on a uniform reporting standard that is unrelated to and independent of type or architecture of welding-type setups.

As utilized herein the terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “example” means serving as a non-limiting example, instance, or illustration. As utilized herein, the terms “e.g.” and for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

Welding-type power, as used herein, refers to power suitable for welding, plasma cutting, induction heating, CAC-A (carbon arc cutting/air) and/or hot wire welding/preheating (including laser welding and laser cladding). Welding-type power supply, as used herein, refers to a power supply that can provide welding-type power. A welding-type power supply may include power generation components (e.g., engines, generators, etc.) and/or power conversion circuitry to convert primary power (e.g., engine-driven power generation, mains power, etc.) to welding-type power.

Welding-type operations, as used herein, comprise operations in accordance with any known welding technique, including flame welding techniques such as oxy-fuel welding, electric welding techniques such as shielded metal arc welding (e.g., stick welding), metal inert gas welding (MIG), tungsten inert gas welding (TIG), resistance welding, as well as gouging (e.g., carbon arc gouging), cutting (e.g., plasma cutting), brazing, induction heating, soldering, and/or the like.

Welding-type setup, as used herein, refers to any setup comprising welding related devices or equipment (e.g., welding power sources, welding torch, welding gear such as headwear and the like, auxiliary devices or systems, etc.) which are used in facilitating and/or in conjunction with welding-type operations.

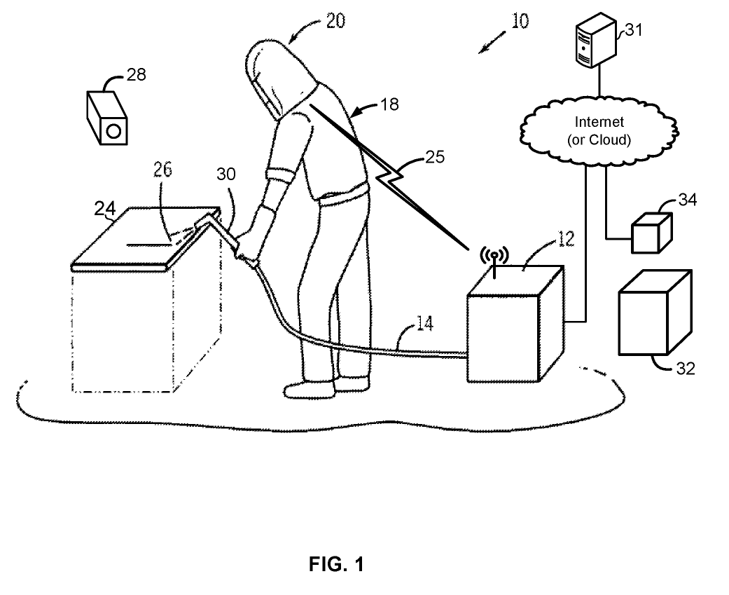

FIG. 1 shows an example system that may be used for welding-type operations, in accordance with aspects of this disclosure.

Referring to FIG. 1, there is shown an example welding-type setup 10 in which an operator 18 is wearing welding headwear 20 and welding a workpiece 24 using a torch 30 to which power is delivered by equipment 12 via a conduit 14, with weld monitoring equipment 28, which may be available for use in monitoring welding operations. The equipment 12 may comprise a power source, optionally a source of a shield gas and, where wire/filler material is to be provided automatically, a wire feeder. Further, in some instances an engine 32 may be used to drive equipment or components used during welding operations. The engine 32 may comprise a gas engine or a liquefied petroleum (LP) engine. The engine 32 may drive generators, power sources, etc. used during welding operations.

The welding-type setup 10 of FIG. 1 may be configured to form a weld joint by any known welding-type technique.

Optionally in any implementation, the welding equipment 12 may be arc welding equipment that provides a direct current (DC) or alternating current (AC) to a consumable or non-consumable electrode 16 of a torch 30. The electrode 16 delivers the current to the point of welding on the workpiece 24. In the welding-type setup 10, the operator 18 controls the location and operation of the electrode 16 by manipulating the torch 30 and triggering the starting and stopping of the current flow. In other implementations, a robot or automated fixture may control the position of the electrode and/or may send operating parameters or trigger commands to the welding system. When current is flowing, an arc 26 is developed between the electrode and the workpiece 24. The conduit 14 and the electrode 16 thus deliver current and voltage sufficient to create the electric arc 26 between the electrode 16 and the workpiece. The arc 26 locally melts the workpiece 24 and welding wire or rod supplied to the weld joint (the electrode 16 in the case of a consumable electrode or a separate wire or rod in the case of a non-consumable electrode) at the point of welding between electrode 16 and the workpiece 24, thereby forming a weld joint when the metal cools.

Optionally in any implementation, the weld monitoring equipment 28 may be used to monitor welding operations. The weld monitoring equipment 28 may be used to monitor various aspects of welding operations, particularly in real-time (that is as welding is taking place). For example, the weld monitoring equipment 28 may be operable to monitor arc characteristics such as length, current, voltage, frequency, variation, and instability. Data obtained from the weld monitoring may be used (e.g., by the operator 18 and/or by an automated quality control system) to ensure proper welding.

As shown, the equipment 12 and headwear 20 may communicate via a link 25 via which the headwear 20 may control settings of the equipment 12 and/or the equipment 12 may provide information about its settings to the headwear 20. Although a wireless link is shown, the link may be wireless, wired, or optical.

Optionally in any implementation, equipment or components used during welding operations may be driven using engines. For example, the engine 32 may drive generators, power sources, etc. used during welding operations. In some instances, it may be desired to obtain information relating to used engines. For example, data relating to engines (and operations thereof) used during welding operations may be collected and used (e.g., based on analysis thereof) in monitoring and optimizing operations of these engines. The collection and use of such data may be performed telematically—that is, the data may be collected locally, subjected to at least some processing locally (e.g., formatting, etc.), and then may be communicated to remote management entities (e.g., centralized management locations, engine providers, etc.), using wireless technologies (e.g., cellular, satellite, etc.).

Optionally in any implementation, a dedicated controller (e.g., shown as element 34 in FIG. 1) may be used to control, centralize, and/or optimize data handling operations. The controller 34 may comprise suitable circuitry, hardware, software, or any combination thereof for use in performing various aspects of the engine related data handling operations. For example, the controller 34 may be operable to interface with the engine 32 to obtain data related thereto. The controller 34 may track or obtain welding related data (e.g., from weld monitoring equipment 28, from equipment 12, etc.). The controller 34 may then transmit the data (e.g., both engine related and weld related data), such as to facilitate remote monitoring and/or management, by way of wireless communications. This may be done using cellular and or satellite telematics hardware, for example.

In some example implementations, welding-type systems or setups, such as the welding-type setup 10, may be configured for collecting and reporting data relating to welding-type operations and/or to functions or components utilized during welding-type operations. For example, data from welding processes, power sources, welding-related accessories etc. in a weld setup may be collected. In this regard, the collected data may comprise, for example, current, voltage, wire feed speed, weld states, and numerous other power source parameters and settings. The collected data may then be sent to remote entities (e.g., a remote server 31, which may be a manufacturer-controlled, Internet-based cloud server) and/or to local systems or devices (e.g., local PC, a tablet, a smartphone, etc.). The collected data may be utilized in enhancing welding-related systems and/or operations. For example, manufacturers may utilize the collected data to identify issues (and correct them) and/or devise modifications or improvements in the various components. Also, users may be able to generate reports on collected data to measure, document, and improve their processes.

Various solutions may be used to handle the collection and reporting of data. For example, in some instances, integrated data collection and reporting entities (comprising suitable hardware and software) may be used. In this regard, a single device (which may be a dedicated device, and/or may be implemented using existing resources, such as the controller 34) may be configured for collecting the required data, for storing the data, as well as for establishing connections (Internet or cloud connections) to the remote entities and sending the data using the established connections.

However, various issues arise with conventional solutions. In particular, a major drawback or problem with conventional solutions based on the integrated approach is the lack of portability. In this regard, various welding-type systems or setups may have different hardware and software architectures, which would impact the data collections functions (which require interactions with the local systems), even when the reporting functions may not be affected—e.g., because the way in which the data is reported may typically be the same irrespective of the variations in the setups or architectures used therein. This would result in substantial complexity and cost.

For example, for each new implementation of the data collection and reporting function (and configuration and/or re-configuration of components handling these functions), developers must make a decision to build the data collection and reporting function into existing components (e.g., the power source architecture) or to make it a separate entity. In the former case, cloud reporting consumes valuable resources that are not part of the primary function (that is, welding) of the welding-type setup or the component incorporating the data collection and reporting function. Additionally, each new implementation is slightly different since it is matched to the particular architecture of the welding setup or the component incorporation the data collection and reporting function (and each such component may be of an entirely different design).

Therefore, the addition of new reporting feature(s) may require customized modifications (e.g., hardware and/or software) that are unique to each particular type of welding setups and/or pertinent components therein (e.g., the power source thereof). Similarly, in instances where issues (e.g., bugs) are found, an effort has to be made to ensure that these issues are handled for all possible welding platforms, and as such the fixes as well as the related activities (e.g., testing and debugging) are configured for each platform. Alternatively, building cloud reporting hardware and/or software as a separate entity increases the total cost and requires more sophistication (e.g., another microprocessor or additional software and testing).

Accordingly, in accordance with the present disclosure, welding-type systems or setups, such as the welding-type setup 10, may be configured for more optimized and efficient data collection and reporting that overcome shortcomings of existing solutions. In particular, in various implementations in accordance with the present disclosure, separate data collection and reporting entities may be used, with the data collection device (or module) handling the data collection within each welding setup, and as such being variably configured based on the architecture of the intended welding setup, and the cloud reporting device (or module) being designed and configured independent of the welding setups and their corresponding architectures.

In this regard, such remote reporting modules may be implemented as a dedicated and separate hardware component (e.g., board) or software application, and as such may incorporate a communication interface for receiving the collected data from other components that actually collect, and then format the data for the generic cloud reporter and lives as a separate board from the power source hardware. Alternatively, the remote reporting module may be integrated directly into another component of the welding-type system or setup (e.g., a power source board). Either way the reporting module is implemented as separate hardware and software entity that can be designed and/or maintained entirely apart from the other components of the welding-type setup or system. Accordingly, the cloud reporting module may be re-used across many products with little modification, and may be re-configured uniformly without needing to account for variations in the welding setups, as described in more detail below.

In this regard, because the reporting module and/or reporting related functions are implemented independent of the welding setups or systems, faster development cycles may be achieved as the cloud reporting module may be re-used across many different products with little modification. Further, there is only one codebase to maintain for all products which makes more efficient use of resources. Thus, porting reporting modules implemented in accordance with the present disclosure to new welding setups or systems may be greatly simplified (requiring only ensuring that the reporting module are able to interface with other components, which if a commonly available interface such as USB is utilized, would be fairly simple to do), without require a whole new development based on the new architecture.

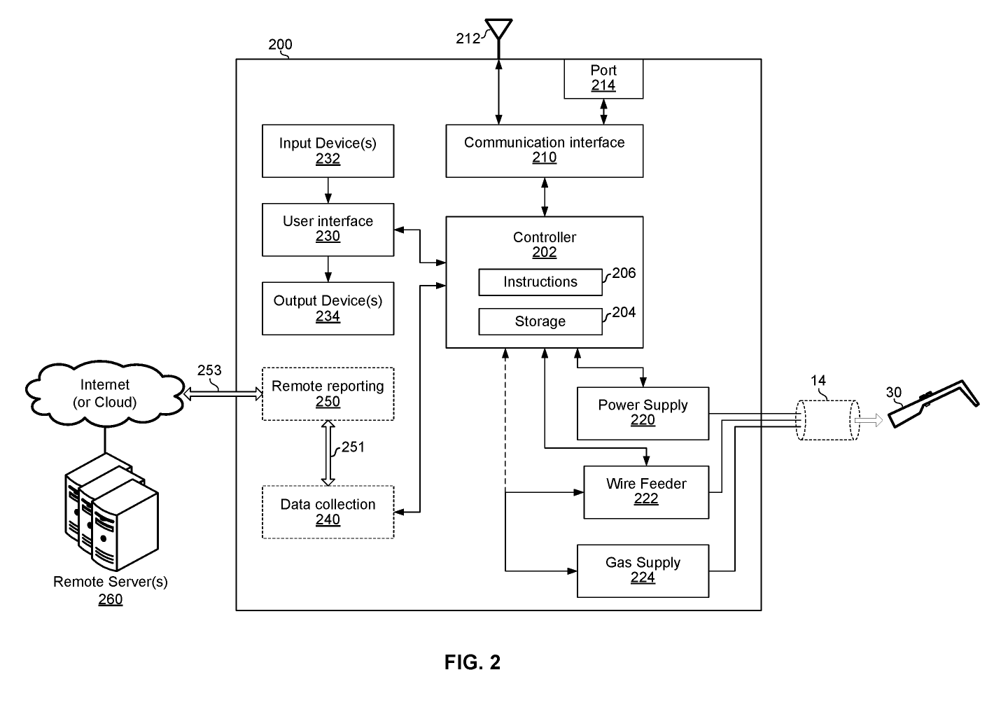

FIG. 2 depicts an example welding-type system that utilized re-usable and re-configurable reporting module, in accordance with aspects of this disclosure. Shown in FIG. 2 is an example welding-type system 200.

As shown in FIG. 2, the welding-type system 200 may comprise a controller, communication interface module 210, a power supply 220, the wire feeder 222, and/or the gas supply 224, a user interface module 230, a data collection module 240, and a remote reporting module 250.

The controller 202 comprises suitable circuitry (e.g., a microcontroller and memory) for controlling operations of the welding-type system 200 and/or functions associated therewith. For example, the controller 202 may be operable to, for example, process data received from the communication interface module 210, the user interface module 230, the power supply 220, the wire feeder 222, and/or the gas supply 224, generate data and/or control signals for the communication interface module 210, the user interface module 230, the power supply 220, the wire feeder 222, and/or the gas supply 224, etc., and the like.

The controller 202 may comprise digital and/or analog circuitry, discrete or integrated circuitry, microprocessors, digital signal processors (DSPs), field programmable gate arrays (FPGAs), and/or any other type of logic circuits. The controller 202 may be implemented using any combination of software, hardware, and/or firmware. The controller 202 may be configured to execute machine readable instructions 206 which may be stored in storage device(s) 204, which may comprise volatile and/or non-volatile memory, hard drives, solid state storage, and the like.

The communication interface module 210 is operable to interface the control circuitry 202 to an antenna 212 and/or port(s) 214 for transmit and receive operations. For transmit, the communication interface module 210 may receive data from the control circuitry 202 and packetize the data and convert the data to physical layer signals in accordance with protocols in use on the communication link 25. For receive, the communication interface module 210 may receive physical layer signals via the antenna 212 or port 214, recover data from the received physical layer signals (demodulate, decode, etc.), and provide the data to control circuitry 202. The antenna 212 may be any type of antenna suited for the frequencies, power levels, etc. used by the communication link 25. The communication port 214 may comprise, for example, an Ethernet over twisted pair port, a USB port, an HDMI port, a passive optical network (PON) port, and/or any other suitable port for interfacing with a wired or optical cable.

The user interface module 230 may comprise electromechanical interface components or devices (e.g., screen, speakers, microphone, buttons, touchscreen, etc.) and associated suitable circuitry for driving, controlling, and utilizing these components or devices. The user interface module 230 may generate electrical signals in response to user input provided via one or more input devices 232 (e.g., screen touches, button presses, voice commands, etc.). Driver circuitry of the user interface module 230 may condition (e.g., amplify, digitize, etc.) the signals and them to the controller 202. The user interface module 230 may generate audible, visual, and/or tactile output (e.g., via speakers, a display, and/or motors/actuators/servos/etc.) which may be provided via one or more output devices 234, in response to signals from the controller 202.

The power supply 220 is configured for generating power—e.g., to be delivered to a welding electrode via conduit 14. The power supply 220 may comprise, for example, one or more voltage regulators, current regulators, inverters, and/or the like. The voltage and/or current output by the power supply 220 may be controlled by a control signal from the controller 202. The power supply 220 may also comprise circuitry for reporting the present current and/or voltage to the controller 202. In an example implementation, the power supply 220 may comprise circuitry for measuring the voltage and/or current on the conduit 14 (at either or both ends of the conduit 14) such that reported voltage and/or current is actual and not simply an expected value based on calibration.

In an example implementation, the power supply 220 may be engine driven. In this regard, the power supply 220 may comprise, for example, an engine, a generator, and power conditioning circuitry. The engine may comprise a gas engine or a liquefied petroleum (LP) engine. The engine may be mechanically coupled or linked to a rotor of the generator. The engine may be controllable to operate at multiple speeds, such as an idle (e.g., no or minimal load speed) and a maximum speed (e.g., the maximum rated power of the engine). The engine speed may be increased and/or decreased, such as based on the load. The generator generates output power based on the mechanical input from the engine. Power conditioning circuitry (not shown) may be used for converting output power from the generator to welding—type power based on a commanded welding-type output. For example, the power conditioning circuitry provides current at a desired voltage to an electrode and a workpiece to perform a welding-type operation. The power conditioning circuitry may comprise, for example, a switched mode power supply or an inverter. The power conditioning circuitry may include a direct connection from a power circuit to the output (such as to the weld studs), and/or an indirect connection through power processing circuitry such as filters, converters, transformers, rectifiers, etc.

The wire feeder 222 is configured to deliver a consumable wire electrode 16 to the weld joint. The wire feeder 222 may comprise, for example, a spool for holding the wire, an actuator for pulling wire off the spool to deliver to the weld joint, and circuitry for controlling the rate at which the actuator delivers the wire. The actuator may be controlled based on a control signal from the controller 202. The wire feeder 222 may also comprise circuitry for reporting the present wire speed and/or amount of wire remaining to the controller 202. In an example implementation, the wire feeder 222 may comprise circuitry and/or mechanical components for measuring the wire speed, such that reported speed is an actual value and not simply an expected value based on calibration.

The gas supply 224 is configured to provide shielding gas via conduit 14 for use during the welding process. The gas supply 224 may comprise an electrically controlled valve for controlling the rate of gas flow. The valve may be controlled by a control signal from the controller 202 (which may be routed through the wire feeder 222 or come directly from the controller 202 as indicated by the dashed line). The gas supply 224 may also comprise circuitry for reporting the present gas flow rate to the controller 202. In an example implementation, the gas supply 224 may comprise circuitry and/or mechanical components for measuring the gas flow rate such that reported flow rate is actual and not simply an expected value based on calibration.

The welding-type system 200 may be configured for optimized and efficient data collection and reporting, in accordance with the present disclosure. In this regard, the welding-type system 200 may incorporate separate data collection and reporting entities, namely the data collection module 240 and the remote reporting module 250, for handling the collection and reporting of data.

The data collection module 240 comprises suitable circuitry for handling collection of data collection within the welding-type system 200. As the data collection module 240 is configured based on the particular architecture of the welding-type system 200. The data collection module 240 may be a dedicated component, or may be implemented using existing circuitry (e.g., as part of the controller 202, the power supply 220, etc.). In this regard, the data collection module 240 may obtained the required data by interacting directly with the various components or devices of the welding-type system 200 (e.g., the power supply 220, etc.), and/or from various sensors (not shown) that the data collection module 240 may be connected to, such as gas/current/voltage sensors, grinders, etc. Alternatively, the data collection module 240 may obtain the data from the controller 202, which typically interacts with all of the components or devices of the welding-type system 200, and as such would be able to handled obtaining the required data.

The remote reporting module 250 comprises suitable circuitry for handling reporting of collected data—that is, providing collected data to remote entities, such as remote server(s) 260. The data may also be reported to other types of systems or devices, which may be tasked with receiving, storing, and utilizing (e.g., analysis and/or making updates based thereon) of reporting data. Examples of such other systems or device may include local PC, a smartphone, a tablet, a plant management system (e.g., a manufacturing execution systems (MES) or an enterprise resource planning (ERP) based system), a robot controller, a programmable logic controller (PLC), a human machine interface (HMI) based device, or other intelligent device. In this regard, the remote reporting module 250 may be designed and/or configured independent of the welding setups and their corresponding architectures. Rather, the only restriction would be that the remote reporting module 250 be able to interact with the data collection component in the setups. Thus, to operate within the welding-type system 200, the remote reporting module 250 would only need to be able interact with the data collection module 240, such as via a local interface 251. In this regard, the local interface 251 may comprise any of limited number of possible interfaces (e.g., USB, analog, digital, serial communication, wired, wireless, etc.).

Accordingly, the remote reporting module 250 may be configured to support such possible interfaces, to allow it to pair and interact with the local data collection entity in any systems into which it is incorporated. Once the remote reporting module 250 is able to interact with the local data collection entity, and to obtain collected data therefrom, the remote reporting module 250 may handle the reporting of that data (which may be done in independent manner—that is, independent of the type and/or the architecture of the welding system into which the remote reporting module 250 is incorporated. The reporting of data may be done over a remote interface 253, which may entail establishing connections (e.g., via the Internet or the Cloud) to the remote servers 260 (or other types of systems or devices, as noted above).

In this regard, to facilitate the reporting of collected data, the remote reporting module 250 may incorporate interfacing function for handling establishing and utilizing Internet connections (e.g., Ethernet based connections). Various interface protocols may be used to transfer the data, such as APIs, Ethernet IP, Profibus, Electronic Data Sheets (EDS), and the like. In some instances, routing of the reported data may include sending it via a proxy server to reduce the need of security risk for the remote reporting module 250.

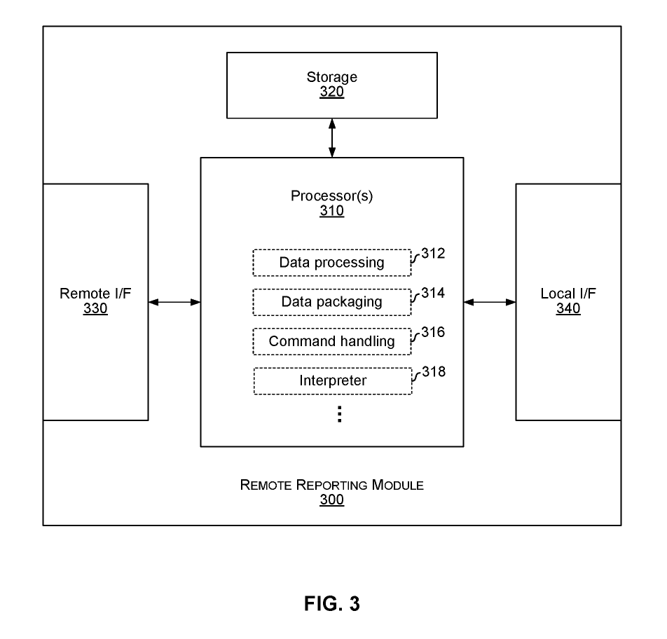

The remote reporting module 250 may also perform other functions that are pertinent to the reporting of data. For example, the remote reporting module 250 may be configured to process the data, such as to enable compliance with particular reporting protocols or messaging standards. The remote reporting module 250 may also be operable to receive commands or other data from the remote entities—e.g., to enable requesting particular data, to update reporting and/or collections features or functions, etc. Where needed the remote reporting module 250 may make any required changes (e.g., to the data collection functions) by interacting with the local data collection functions (e.g., the data collection module 240). An example implementation of the remote reporting module 250 is described with respect to FIG. 3.

In some implementations, the communication interface 210 may be combined with or be replaced by the remote reporting module 250, and/or functions performed thereby may be coordinated with those performed by the remote reporting module 250. In this regard, the signals transmitted through the communication interface may go through the remote reporting module 250, or vice-versa—that is, signals that are to be transmitted from the remote reporting module 250 may go through the communication interface 210 instead, such as to be sent to external intelligent devices (e.g., the Cloud, a remote server, a local PC, a smartphone, a tablets, a PLC, an HMI, etc.), or wireless sensors.

In some implementations, the remote reporting module 250 may be configured to store collected data, such as in accordance with particular storage criteria. For example, the remote reporting module 250 may store collected data when reporting the data is not possible (e.g., due to lack of access to the intended repository system or device, such as when the repository system or device is offline, when connection is available, etc.). The remote reporting module 250 may also store data even when it is possible to report it and/or when it is already reported. For example, data may be stored until its reception is acknowledged by the remote system—that is buffered. The data may also be stored by the remote reporting module 250 regardless of it being reported (successfully) or not. For example, the remote reporting module 250 may be configured to store all reported data, such as in accordance with particular storage criteria (e.g., store it until running out of space, for a particular duration of time, etc.).

In some implementations, the remote reporting module 250 may be configured to handle interpreting functions. In this regard, the remote reporting module 250 may be configured to connect to many types of data collection modules, such as the data collection module 240 in welding-type setup 200 of FIG. 2. The data collection modules and the entities to which the collected data is reported (e.g., the remote server 260 in FIG. 2) may be unable to interpret and scale the received data appropriately without knowing more about the data collection module and what its data and/or data related functions. For example, sensors may announce their capabilities and properties to the data collection module 240 automatically, digitally, via hardware, or upon request. The data collection module 240 then uses this information to configure itself and to send it to the remote reporting module 250, which may in turn use it to inform the intended repository (e.g., the remote server 260) about the capabilities. The sensors may provide their capabilities via analog or digital means in a predetermined format, and then the remote reporting module 250 may re-interpret these capabilities, in a format that can be understood by the intended recipient (e.g., the remote server 260), before sending the reported data.

In some implementations, the remote reporting module 250 and the data collection module 240 may interact prior (or during) reporting operations, such as to negotiate parameters and/or information relating to interfacing between the two modules, to data collection, etc. The remote reporting module 250 sends input data to the data collection module 240 via local interface 251, which may be a digital interface. The data collection module 240 may be on the same board as the reporting module, a parent board, or entirely separate hardware (e.g., welding power source 202) with a communication (wired, wireless, optical, etc.) interface therebetween.

The data structure of the communication interface allows for defining the capabilities of the hardware and sensors associated with the data collection module 240. Upon initial power-up, by request, or reset and initiation of communication the data collection module 240 can report each of its sensors and data reporting parameters. Each reported parameter's data structure may contain the following entities: the parameter measured, range, resolution, sample rate or period, time in use or percent life used (wear), on/off, status, sensor type, ID. Sensors or parameters may be connected to the data collection device by wire, wireless, optical, etc., (either analog or digital for each communication modality). Possible sensors include but not limited to wire feed speed (WFS), travel speed (part, torch, or other), proximity, motion, weight (wire, gas bottle, personnel floor mat, item being fabricated, etc.), heat input, wire diameter, alloy, gas type, gas coverage, wire type, safety gate, light curtain, air use, gas pressure, gas flow, grinder on/off, switch closure, temperature, acceleration, part counter, RFID, barcode, keyboard, traveler (electronic or other), weld sequence, flux sensor, operator activity, etc.

The data collection module 240 can also provide an interface for the reporting module to send data to the welding system (200), controller (202), power source, HMI, robot controller, or PC. This data can be used to display information to the user, control parameters to the power source, set an error state, shut down the system, or information for analysis or control to a PC.

FIG. 3 depicts an example adaptive reporting module, in accordance with aspects of this disclosure. Shown in FIG. 3 is an example remote reporting module 300.

The remote reporting module 300 may comprise suitable circuitry for handling reporting of collected data from welding-type systems or setups. In this regard, the remote reporting module 300 is operable to obtain collected data from local entities (e.g., dedicated data collection modules) and provide that collected data to remote entities. In doing so, the remote reporting module 300 is operable to establish connections with the local entities on one end, and with the remote entities at the other end, and to perform any necessary processing of the data (if needed), such to ensure compliance with particular reporting standards or protocols, to embed the data within suitable packets for transmission to the remote entities, etc. The remote reporting module 300 may correspond to—that is, may represent an example implementation of—the reporting module 250 of FIG. 2.

As shown in FIG. 3, the remote reporting module 300 may comprise a processing component 310, storage component 320, a remote interface (I/F) component 330, and a local interface (I/F) component 340.

The processing component 310 comprises suitable circuitry for performing processing operations in the remote reporting module 300. For example, the processing component 310 may be operable to process data (e.g., collected data obtained from local entities); run or execute various functions, tasks, and/or applications; and/or configure, control, and/or manage operations of the remote reporting module 300 and/or other components and/or subsystems (or operations thereof) in the remote reporting module 300. For example, the processing component 310 may incorporate a data processing function 312 configure for processing collected data, such as to enable compliance with particular reporting protocols or messaging standards; a data packaging function 314 for packaging the collected data in accordance with particular reporting protocols or messaging standards; a command handling function 316 for handling received commands (requesting particular data, updating reporting and/or collections features or functions, etc.) from remote entities, etc.; an interpreter function 318 for handling the interpretation of data and/or negotiations with local components (e.g., local data collection module or device), as described with respect to FIG. 2; etc.

The storage component 320 may comprise suitable circuitry for providing permanent and/or non-permanent storage, buffering, and/or fetching of data, which may be used, consumed, and/or processed in the remote reporting module 300. In this regard, the storage component 320 may comprise different memory technologies, including, for example, read-only memory (ROM), random access memory (RAM), Flash memory, solid-state drive (SSD), and/or field-programmable gate array (FPGA). The storage component 320 may store, for example, configuration data, which may comprise parameters and/or code, comprising software and/or firmware; functions or system settings; libraries; etc. In some implementations, the storage component 320 may be used to store the collected data, such as in accordance with particular storage criteria, as described above with respect to FIG. 2.

The remote I/F component 330 may comprise suitable circuitry for supporting communication of data between the remote reporting module 300 and external (remote or local) repository entities tasked with handling and utilizing the reported data. The remote I/F component 330 may handle establishing and/or utilizing remote interfaces (e.g., the remote interface 253 in FIG. 2) to remote (or local) systems or devices, external to the welding-type setup. For example, the remote I/F component 330 may comprise circuitry for establishing connections, such as over wired and/or wireless interfaces; for handling transmission and/or reception of signals over the established connections; and/or for performing necessary signal processing functions associated with the transmission and/or reception of signals. The remote I/F component 330 may be configured to establish Ethernet based connections, and/or for handling sending and/or reception of Ethernet packets over these connections.

The local I/F component 340 may comprise suitable circuitry for supporting data between the remote reporting module 300 and other local entities in a system or setup in which the remote reporting module 300 is incorporated. The local I/F component 340 may handle establishing and/or utilizing local interfaces to the local components or devices within the welding-type device (e.g., the local interface 251 in FIG. 2). For example, the local I/F component 340 may comprise circuitry for establishing connections over various possible internal interfaces; and/or for performing necessary signal processing functions associated with the transmission and/or reception of signals over these connections. The local I/F component 340 may be configured to establish USB based connections, analog, digital, serial communication, wired, wireless, etc., and/or for handling sending and/or reception of data over these connections.

In an example implementation, the remote reporting module 300 may be implemented as single board computer (SBC) or a system on a module (SOM) based hardware, running application level operating systems (e.g., Linux). As such, with such implementation, all of the reporting functionality (and related operations and/or functions) may be encapsulated into a single SBC or a single SOM based device (or chip) that can be ported to each new development. Accordingly, the remote reporting module 300 may be identical in both hardware and software regardless of the welding-type setup or system into which it is incorporated. Therefore any updates, either feature adds or bug fixes, only need to be made once. This saves a tremendous amount of engineering time from having to maintain multiple systems.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A hardware-based reporting module, comprising:
one or more communication circuits configured to:
interface with a welding-type setup, to obtain welding-type data associated with the welding-type setup; and
interface with a remote central repository for communicating the obtained welding-type data, based on a predefined reporting format, wherein the predefined reporting format is based on a uniform reporting standard that is unrelated to and independent of type and/or architecture of welding-type setups; and
one or more processing circuits configured to process the welding-type data for communication to the remote central repository.

2. The hardware-based reporting module of claim 1, wherein the one or more communication circuits are configured to interface with a dedicated data collection component of the welding-type setup that handles collection of welding-type data from remaining components of the welding-type setup.

3. The hardware-based reporting module of claim 1, wherein one or more processing circuits are operable to generate packets carrying the obtained welding-type data based on the uniform reporting standard.

4. The hardware-based reporting module of claim 1, wherein one or more processing circuits are operable to process the obtained welding-type data to conform to a uniform and a common format.

5. The hardware-based reporting module of claim 1, wherein:
the obtained welding-type data comprises information relating to capabilities of one or more components of the welding-type setup; and
the one or more processing circuits are operable to re-format the capabilities related information such that the remote central repository is able to determine the capabilities of the one or more components in the welding-type setup.

6. The hardware-based reporting module of claim 1, wherein the hardware-based reporting module is implemented as a single board computer (SBC).

7. The hardware-based reporting module of claim 1, wherein the hardware-based reporting module is implemented as a system on a module (SOM).

8. The hardware-based reporting module of claim 1, wherein:
the one or more communication circuits are configured to receive from the remote central repository updates or modifications to reporting functions; and
the one or more processing circuits are configured to apply the updates or modifications.

9. The hardware-based reporting module of claim 1, comprising a storage circuit, and wherein the storage circuit is operable to store the obtained welding-type data in accordance with one or more storage criteria.

10. The hardware-based reporting module of claim 1, wherein the hardware-based reporting module is incorporated into a component of the welding-type setup.

11. The hardware-based reporting module of claim 10, wherein the component of the welding-type setup comprises one of:
a welding-type power supply for providing welding-type power;
a welding-type torch, driven by the welding-type power supply, configured for applying welds;
a welding-type connector configured for connecting the welding-type power supply to the welding-type torch; and
a dedicated data collection component that is operable to handle collection of welding-type data from remaining components of the welding-type setup.

12. A system, comprising:
a data collection component configured based on a particular architecture of a welding-type setup, the data collection component comprising one or more circuits for collecting welding-type data from the welding-type setup; and
a reporting component configured based on a uniform architecture that is independent from the particular architecture of the welding-type setup, the reporting component comprising one or more circuits for handling reporting the collected welding-type data;
wherein:
the data collection component is operable to interface with one or more components of the welding-type setup to collect the welding-type data; and
the reporting component is operable to:
interface with the data collection component to obtain the collected welding-type data; and
interface with a remote central repository to communicate the collected welding-type data based on a uniform reporting standard.

13. The system of claim 12, wherein the reporting component is operable to process the collected welding-type data based on a predefined reporting format.

14. The system of claim 13, wherein the predefined reporting format comprises a uniform format that is independent of type and/or architecture of welding-type setups.

15. The system of claim 12, wherein:
the collected welding-type data comprises information relating to capabilities of at least one of the one or more components of the welding-type setup; and
the reporting component is operable to re-format the capabilities related information such that the remote central repository is able to determine the capabilities of the at least one of the one or more components of the welding-type setup.

16. The system of claim 12, wherein the reporting component comprises a single board computer (SBC) based circuitry.

17. The system of claim 12, wherein the reporting component comprises a system on a module (SOM) based circuitry.

18. The system of claim 12, wherein the reporting component is operable to generate packets carrying the obtained welding-type data based on the uniform reporting standard.

19. The system of claim 12, wherein the reporting component is operable to store the obtained welding-type data in accordance with one or more storage criteria.

20. The system of claim 12, wherein the reporting component is operable to:
receive from the remote central repository updates or modifications to reporting functions; and
apply the updates or modifications.

21. The system of claim 12, wherein one or both of the data collection component and the reporting component are incorporated into one of the one or more components of the welding-type setup.

22. The system of claim 12, wherein the one or more components comprise:
a welding-type power supply for providing welding-type power;
a welding-type torch, driven by the welding-type power supply, configured for applying welds; and
a welding-type connector configured for connecting the welding-type power supply to the welding-type torch.
